(19) United States
(12) Patent Application Publication
(10) Pub. No.: US 2021/0328944 A1
(43) Pub. Date: Oct. 21, 2021

(54) METHODS, APPARATUS, AND ARTICLES OF MANUFACTURE TO DYNAMICALLY ALLOCATE CACHE

(71) Applicant: Intel Corporation, Santa Clara, CA (US)

(72) Inventor: Kishore Kasichainula, Phoenix, AZ (US)

(21) Appl. No.: 17/359,139

(22) Filed: Jun. 25, 2021

(51) Int. Cl. H04L 12/861; H04L 29/08

(52) U.S. Cl. CPC H04L 49/9005; H04L 49/90; H04L 67/2842

(57) ABSTRACT

Methods, apparatus, systems, and articles of manufacture are disclosed to dynamically allocate cache. An example includes a cache having a queue, data stream classification circuitry, and cache management circuitry. In an example, the data stream classification circuitry is configured to decode a data stream assigned to the queue of the cache to determine a traffic class assigned to the queue. In additional or alternative examples, the cache management circuitry is configured to, based on the traffic class assigned to the queue, allocate a portion of the cache to the queue. In some examples, the cache management circuitry is configured to transmit a signal to a memory controller to adjust allocation of the cache.

### FIELD OF THE DISCLOSURE

This disclosure relates generally to cache management, and, more particularly, to methods, apparatus, and articles of manufacture to dynamically allocate cache.

### BACKGROUND

Multi-access edge computing (MEC) is a network architecture concept that enables cloud computing capabilities and an infrastructure technology service environment at the edge of a network, such as a cellular network. Using MEC, data center cloud services and applications can be processed closer to an end user or computing device to improve network operation.

### BRIEF DESCRIPTION OF THE DRAWINGS

FIG. 1 illustrates an overview of an Edge cloud configuration for Edge computing.

FIG. 2 illustrates operational layers among endpoints, an Edge cloud, and cloud computing environments.

FIG. 3 illustrates an example approach for networking and services in an Edge computing system.

FIG. 4 illustrates example levels of an example information technology (IT)/operational technology (OT) environment.

FIG. 5 is a block diagram of an example network interface circuitry (NIC) that may be implemented in one or more edge devices and/or one or more IT/OT devices of FIGS. 1, 2, 3, and/or 4.

FIG. 6 is a block diagram illustrating an example implementation of the example cache control circuitry of FIG. 5.

FIG. 7 is an example graphical illustration demonstrating example advantages of examples disclosed herein as compared to existing technology.

FIG. 8 is a flowchart representative of example machine-readable instructions and/or operations that may be executed and/or instantiated by example processor circuitry to implement the example cache control circuitry of FIGS. 5 and/or 6.

FIG. 9 is a block diagram of an example processing platform including processor circuitry structured to execute and/or instantiate the example machine-readable instructions and/or operations of FIG. 8 to implement the example cache control circuitry of FIGS. 5 and/or 6.

FIG. 10 is a block diagram of an example implementation of the processor circuitry of FIG. 9.

FIG. 11 is a block diagram of another example implementation of the processor circuitry of FIG. 9.

FIG. 12 is a block diagram of an example software distribution platform (e.g., one or more servers) to distribute software (e.g., software corresponding to the example machine-readable instructions of FIG. 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processor circuitry is/are best suited to execute the computing task(s). As used herein, the acronym “ASIC” stands for application specific integrated circuitry.

### DETAILED DESCRIPTION

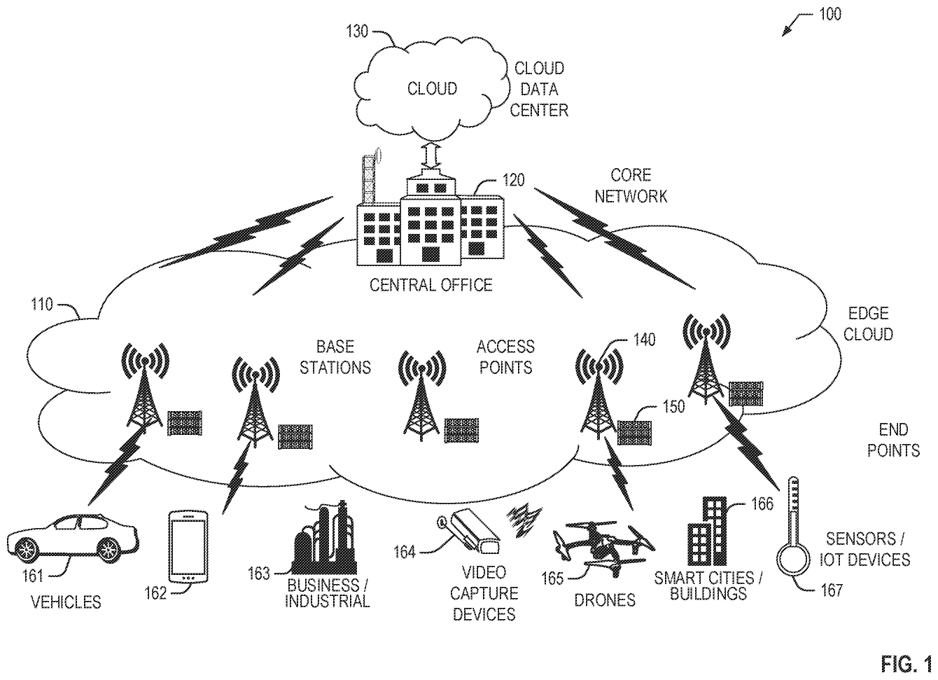

FIG. 1 is a block diagram 100 showing an overview of a configuration for edge computing, which includes a layer of processing referred to in many of the following examples as an “edge cloud.” As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and Internet-of-Things (IoT) devices 167, etc.) than the cloud data center 130. Compute, memory, and storage resources that are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. For example, such processing can consume a disproportionate amount of bandwidth of processing resources closer to the end user or computing device thereby increasing latency, congestion, and power consumption of the network. Thus, edge computing attempts to reduce the amount of resources needed for network services, through the distribution of more resources which are located closer both geographically and in network access time. In this manner, edge computing attempts to bring the compute resources to the workload data where appropriate, or bring the workload data to the compute resources. As used herein, data is information in any form that may be ingested, processed, interpreted and/or otherwise manipulated by processor circuitry to produce a result. The produced result may itself be data.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In contrast to the network architecture of FIG. 1, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage, but is not optimal for highly time varying data, such as a collision, traffic light change, industrial applications, automotive applications, etc. and may fail in attempting to meet latency challenges.

Depending on the real-time requirements in a communications context, a hierarchical structure of data processing and storage nodes may be defined in an edge computing deployment. For example, such a deployment may include local ultra-low-latency processing, regional storage, and processing as well as remote cloud data-center based storage and processing. Key performance indicators (KPIs) may be used to identify where sensor data is best transferred and where it is processed or stored. This typically depends on the ISO layer dependency of the data. For example, lower layer (PHY, MAC, routing, etc.) data typically changes quickly and is better handled locally in order to meet latency requirements. Higher layer data such as Application Layer data is typically less time critical and may be stored and processed in a remote cloud data-center. At a more generic level, an edge computing system may be described to encompass any number of deployments operating in the edge cloud 110, which provide coordination from client and distributed computing devices.

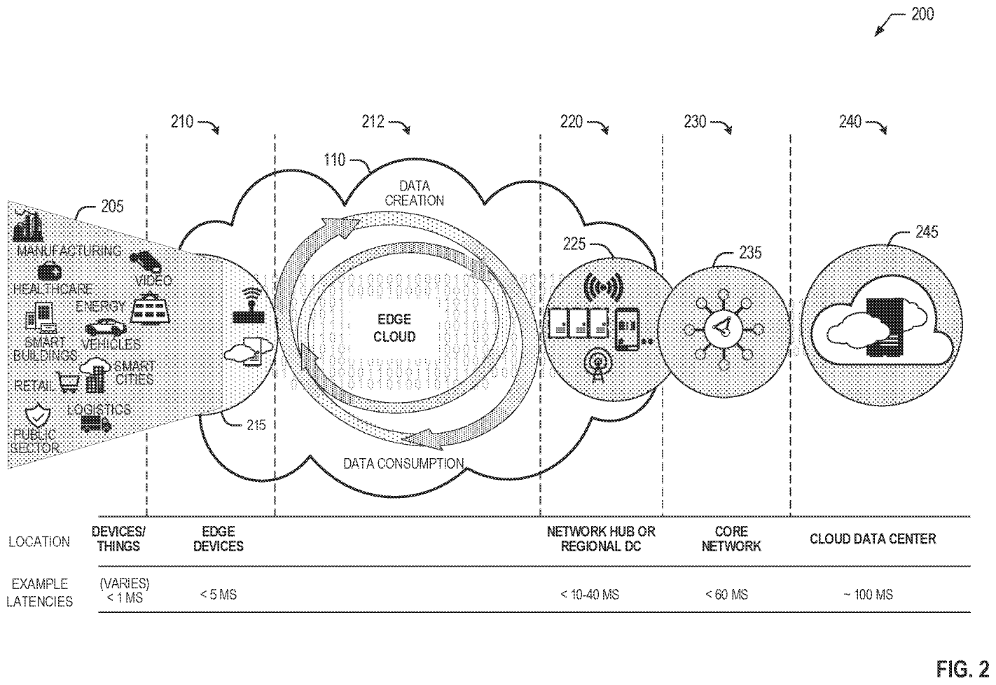

FIG. 2 illustrates operational layers among endpoints, an edge cloud, and cloud computing environments. Specifically, FIG. 2 depicts examples of computational use cases 205, utilizing the edge cloud 110 of FIG. 1 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer 240). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to service level agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (e.g., virtual network functions (VNFs), FaaS, Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 210-230), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to RAN capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, light emitting diodes (LEDs), speakers, I/O ports (e.g., universal serial bus (USB)), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include IoT devices. The appliance computing device may include hardware and software components to manage local issues such as device temperature, vibration, resource utilization, updates, power issues, physical and network security, etc. The edge cloud 110 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code, or scripts.

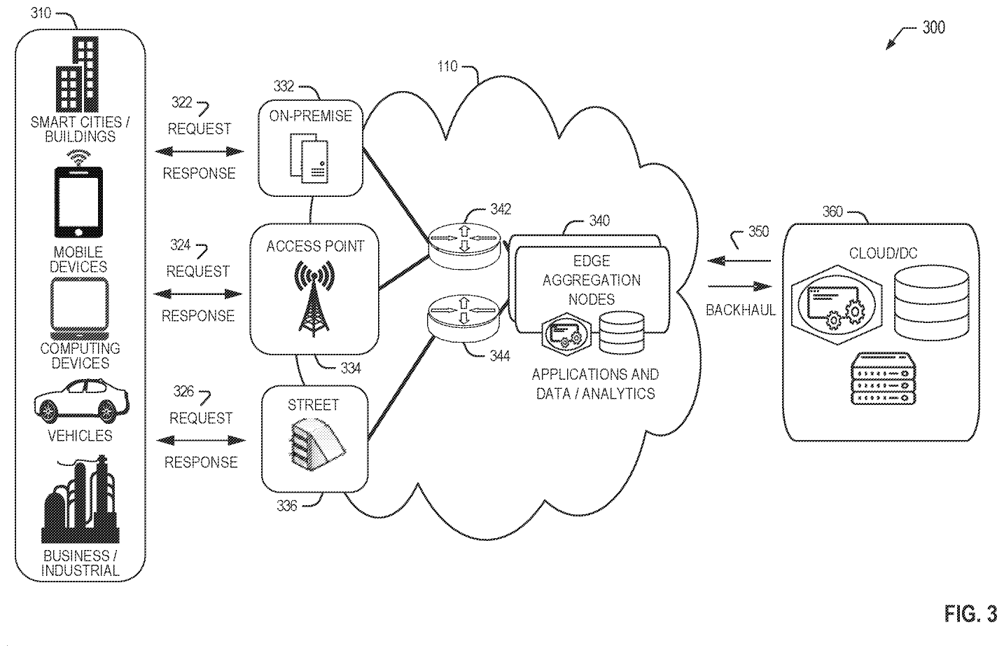

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 of FIG. 1 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center (DC) 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

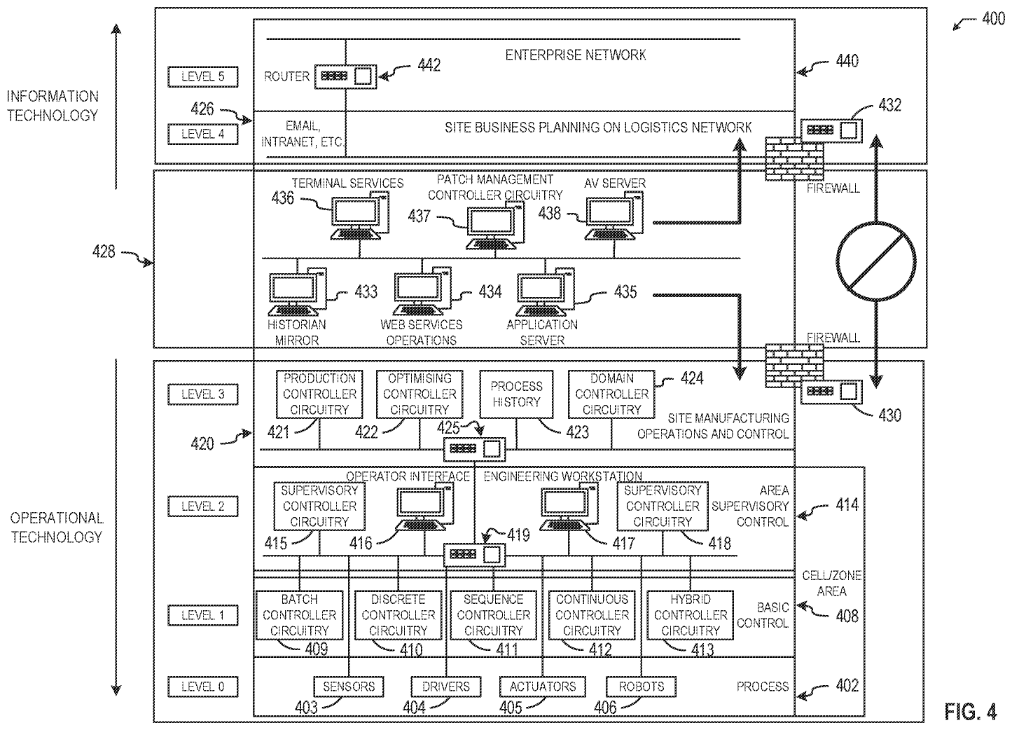

FIG. 4 illustrates example levels of an example IT/OT environment 400. In the example of FIG. 4, the IT/OT environment 400 implements an industrial control system (ICS) that controls a manufacturing and/or other production process. In the example of FIG. 4, the IT/OT environment 400 includes six functional levels representative of hierarchical functions of devices and/or equipment and the interconnections and interdependencies of an example IT/OT environment such as an ICS. The IT/OT environment 400 includes an example level zero 402 corresponding to physical processes. In the example of FIG. 4, physical equipment that performs the actual physical processes reside in the level zero 402. For example, the level zero 402 includes one or more example sensors 403, one or more example drives 404 (e.g., one or more motors), one or more example actuators 405, and one or more example robots 406. In some examples, the level zero 402 includes one or more additional or alternative devices.

In the illustrated example of FIG. 4, the IT/OT environment 400 includes an example level one 408 corresponding to individual control of the respective one or more physical processes of the level zero 402. In the example of FIG. 4, the level one 408 includes example batch controller circuitry 409, example discrete controller circuitry 410 (e.g., one or more proportional-integral-derivative (PID) controllers, one or more open loop controllers, etc.), example sequence controller circuitry 411 (e.g., one or more sequential controllers with interlock logic), example continuous controller circuitry 412 (e.g., performing continuous process control), and example hybrid controller circuitry 413 (e.g., one or more specialized controllers providing capabilities not found in standard controllers such as adaptive control, artificial intelligence, and fuzzy logic). In some examples, the level one 408 includes one or more additional or alternative controllers such as those performing ratio control, feed-forward control, cascade control, and multivariable process control. In the example of FIG. 4, any of the batch controller circuitry 409, the discrete controller circuitry 410, the sequence controller circuitry 411, the continuous controller circuitry 412, and the hybrid controller circuitry 413 may be implemented by one or more programmable logic controllers (PLC(s)). As used herein, the terms controller and/or controller circuitry is a type of processor circuitry and may include one or more of analog circuit(s), digital circuit(s), logic circuit(s), programmable microprocessor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Array (FPGAs).

In the illustrated example of FIG. 4, the IT/OT environment 400 includes an example level two 414 corresponding to control of the one or more controllers of the level one 408. In the example of FIG. 4, the level two 414 includes an ICS such a human machine interface (HMI) system and/or a supervisory control and data acquisition (SCADA) system to supervise, monitor, and/or control the one or more controllers of the level one 408. In the example of FIG. 4, the level two 414 includes example first supervisory controller circuitry 415 (e.g., an HMI system, a SCADA system, etc.), an example operator interface 416, an example engineering workstation 417, and example second supervisory controller circuitry 418 (e.g., an HMI system, a SCADA system, etc.). In the example of FIG. 4, the operator interface 416 and the engineering workstation 417 are implemented by one or more computers (e.g., laptops, desktop computers, etc.).

In the illustrated example of FIG. 4, the first supervisory controller circuitry 415, the operator interface 416, the engineering workstation 417, and the second supervisory controller circuitry 418 communicate with the one or more controllers and/or devices of the level one 408 and the level zero 402 via an example first aggregation point 419. In the example of FIG. 4, the first aggregation point 419 is implemented by a router. In some examples, the first aggregation point 419 is implemented by a gateway, a router and a modem, a network switch, a network hub, among others.

In the illustrated example of FIG. 4, the IT/OT environment 400 includes an example level three 420 corresponding to manufacturing execution systems that manage production workflow on the manufacturing floor (e.g., the level zero 402). In some examples, the level three 420 includes customized systems for certain functions such as batch management, record data, management operations, and overall manufacturing plant performance. In the example of FIG. 4, the level three 420 includes example production controller circuitry 421, example optimizing controller circuitry 422 (e.g., performing optimal control), an example process history database 423 (e.g., to record data associated with one or more physical processes), and example domain controller circuitry 424 (e.g., one or more servers that control the security of network domain of the level zero 402, the level one 408, the level two 414, and the level three 420).

In some examples, the production controller circuitry 421, the optimizing controller circuitry 422 (e.g., performing optimal control), the process history database 423, and/or the domain controller circuitry 424 aggregate and/or process lower level data (e.g., from the level zero 402, the level one 408, and/or the level two 414) and forward the aggregated and/or processed data to upper levels of the IT/OT environment 400. In the example of FIG. 4, the production controller circuitry 421, the optimizing controller circuitry 422 (e.g., performing optimal control), the process history database 423, and the domain controller circuitry 424 communicate with the one or more controllers, one or more interfaces, one or more workstations, and/or one or more devices of the level two 414, the level one 408, and the level zero 402, via an example second aggregation point 425. In the example of FIG. 4, the second aggregation point 425 is implemented similarly to the first aggregation point 419.

In the illustrated example of FIG. 4, the IT/OT environment 400 includes an example level four 426 that is separated from the level three 420, the level two 414, the level one 408, and the level zero 402 by an example demilitarized zone (DMZ) 428. In the example of FIG. 4, the DMZ 428 corresponds to one or more security systems such as one or more firewalls, and/or one or more proxies that regulate (e.g., moderate, police, etc.) bidirectional data flow between the level three 420, the level two 414, the level one 408, the level zero 402 and upper levels (e.g., the level four 426) of the IT/OT environment 400. The example DMZ 428 permits the exchange of data between the highly secure, highly connected upper level networks (e.g., business networks) of the IT/OT environment 400 and the less secure, less connected lower level networks (e.g., ICS networks) of the IT/OT environment 400.

In the illustrated example of FIG. 4, the lower levels (e.g., the level three 420, the level two 414, the level one 408, and the level zero 402) of the IT/OT environment 400 communicate with the DMZ 428 via an example third aggregation point 430. Additionally, the DMZ 428 communicates with the upper levels (e.g., the level four 426) of the IT/OT environment 400 via an example fourth aggregation point 432. In the example of FIG. 4, each of the third aggregation point 430 and the fourth aggregation point 432 is implemented similarly to the first aggregation point 419 and the second aggregation point 425 except that each of the third aggregation point 430 and the fourth aggregation point 432 implements a firewall.

In the illustrated example of FIG. 4, the DMZ 428 includes an example historian server 433 (e.g., implemented by one or more computers and/or one or more memories), example web service operations controller circuitry 434 (e.g., implemented by one or more computers and/or one or more memories), an example application server 435 (e.g., implemented by one or more computers and/or one or more memories), an example terminal server 436 (e.g., implemented by one or more computers and/or one or more memories), example patch management controller circuitry 437 (e.g., implemented by one or more computers and/or one or more memories), and an example antivirus server 438 (e.g., implemented by one or more computers and/or one or more memories). In the example of FIG. 4, the historian server 433 manages incoming and/or outgoing data, storage oof the data, compression of the data, and/or retrieval of the data. In the example of FIG. 4, the web service operations controller circuitry 434 controls Internet-based direct application-to-application interaction via an extensible markup language (XML) based information exchange system.

In illustrated the example of FIG. 4, the application server 435 hosts applications. In the example of FIG. 4, the terminal server 436 provides terminals (e.g., computers, printers, etc.) with a common connection point to a local area network (LAN) or wide area network (WAN). In the example of FIG. 4, the patch management controller circuitry 437 manages the retrieval, testing, and installation of one or more patches (e.g., code changes, updates, etc.) on existing applications and software (e.g., the applications hosted by the application server 435). In the example of FIG. 4, the antivirus server 438 manages antivirus software.

In the illustrated example of FIG. 4, the IT/OT environment 400 includes the level four 426 corresponding to IT systems such as email and intranet, among others. In the example of FIG. 4, the level four 426 includes one or more IT networks including enterprise resource planning (ERP) systems, databases servers, application servers, and file servers that facilitate business logistics systems such as site business planning and logistics networking.

In the illustrated example of FIG. 4, the IT/OT environment 400 includes an example level five 440 corresponding to one or more corporate (e.g., enterprise) networks. In the example of FIG. 4, the level five 440 includes one or more enterprise IT systems that cover communications with the Internet. In the example of FIG. 4, one or more devices in the level five 440 communicate with one or more devices in the level four 426 via an example fifth aggregation point 442. In the example of FIG. 4, the fifth aggregation point 442 is implemented similarly to the first aggregation point 419 and the second aggregation point 425.

In the illustrated example of FIG. 4, the level zero 402, the level one 408, the level two 414, and the level three 420 correspond to the OT portion of the IT/OT environment 400. Within the OT portion, the level zero 402, the level one 408, and the level two 414 form an example cell/zone area. In the example of FIG. 4, the level four 426 and the level five 440 form the IT portion of the IT/OT environment 400.

In the illustrated example of FIG. 4, one or more of the first aggregation point 419, the second aggregation point 425, the third aggregation point 430, the fourth aggregation point 432, the fifth aggregation point 442, the batch controller circuitry 409, the discrete controller circuitry 410, the sequence controller circuitry 411, the continuous controller circuitry 412, the hybrid controller circuitry 413, the first supervisory controller circuitry 415, the operator interface 416, the engineering workstation 417, and the second supervisory controller circuitry 418, the production controller circuitry 421, the optimizing controller circuitry 422, the process history database 423, the domain controller circuitry 424, the historian server 433, the web service operations controller circuitry 434, the application server 435, the terminal server 436, the patch management controller circuitry 437, and/or the antivirus server 438 integrate edge compute, devices, IT-enabled software, and/or one or more applications directed to productivity, reliability, and/or safety.

As the IT/OT environment 400 implements an ICS that controls a manufacturing and/or other production process, some of the processes may be time sensitive. Accordingly, the Institute of Electrical and Electronics Engineers (IEEE) has developed standards to handle such time sensitive processes. For example, the emerging IEEE standards for deterministic networking, referred to collectively as time sensitive networking (TSN), provide extremely precise data transfer across a network. As a result, embedded designs (e.g., any of the devices of the IT/OT environment 400) in industrial and/or automotive environments (e.g., the IT/OT environment 400) are increasingly integrating TSN controllers. TSN controllers may be implemented by network interface circuitry (NIC) based on the capabilities of the NIC. As used herein, NIC refers to Network Interface Circuitry. A NIC may or may not be implemented on a card. With the increasing convergence of IT and OT environments, workload consolidation and demand for seamless communication across many connected devices are imposing higher bandwidth, shorter end-to-end latency, and hard real-time requirements for embedded designs.

Additionally, as link speeds are increasingly getting higher due to high bandwidth requirements and die disaggregation, meeting packet transmit latencies at the line rate is becoming extremely difficult. As used herein, link speed refers to a theoretically maximum speed, measured in bits per second, that a first device can communicate with a second device to which the first device is linked. As used herein, line rate refers to an actual speed with which one or more bits are sent onto a wire. In some examples, line rate is referred to as physical layer gross bit rate. As used herein, die disaggregation refers to the placement of one or more die (e.g., a die implementing NIC) within an embedded design (e.g., a system on a chip (SoC)) farther and farther from one or more other die (e.g., compute, a processor, a processor core, etc.) as compared to previous designs of the embedded design (e.g., SoC).

As an example, it is more difficult for NIC to meet the line rate when transmitting a 64-byte (e.g., 64 B) packet at a link speed of 10 gigabits per second (e.g., 10 Gbps) than it is for the NIC to meet the line rate when transmitting a 64 B packet at a link speed of 1 Gbps. It is more difficult for a device (e.g., NIC) to meet the line rate at higher link speeds because, at higher link speeds the delay associated with the device fetching data from memory is much higher than the latency associated with the device transmitting a packet. This difficulty increases as the link speed increases. Additionally, the latencies associated with the device (e.g., NIC) fetching data from memory (e.g., double data rate (DDR) memory) are increasing due to physically larger die and/or due to die disaggregation.

For example, the time it takes for NIC to transmit a 64 B packet at a link speed of 1 Gbps is 576 nanoseconds (ns) whereas the time it takes for the NIC to transmit a 64 B packet at a link speed of 10 Gbps is 57.6 ns. In such an example, 57.6 ns is relatively very small when compared to the 1 microsecond (μs) latency associated with the NIC fetching the data from memory. A common approach to alleviate the latencies of data fetching is to prefetch data and employ a local cache within a device (e.g., NIC) itself. Because transmitting a packet generally requires two prefetch operations (e.g., a first fetch operation for a descriptor of the packet and a second fetch operation for a payload of the packet), devices (e.g., NICs) generally include two caches associated with respective prefetching operations (e.g., a first cache for descriptors of packets and a second cache for data of the packets). Thus, a device (e.g., NIC) prefetches both descriptors and data of packets to meet the line rate.

However, an issue associated with prefetching is that prefetching impacts the die area of the device doing the prefetching (e.g., the NIC). For TSN capable NICs, the impact on the die area may be very large because of the multiple queues in the two caches for transmission and the multiple queues in the two caches for reception. For example, a TSN NIC including 8 transmit queues and 8 receive queues requires 8 times the cache that NIC including the traditional single transmit queue cache and signal receive queue cache (e.g., Ethernet controller cache). Because TSN standards require that each queue in a TSN NIC support the smallest packet defined by TSN standards (e.g., 64 B) at line rate and the smallest packet of any traffic class defined by TSN standards, each queue of a TSN NIC is assigned a dedicated cache (e.g., first cache for descriptors of packets and second cache for data of packets). As a result, TSN NICs require increased cache size. This type of architecture is not scalable for high link speed TSN NICs as it is too expensive to implement. For example, implementing such an architecture for high link speed TSN NICs would increase the energy consumed to move data into and out of the cache, the physical size (e.g., area) of the cache on a die, and the latency associated with moving data into and out of the cache.

Additionally, in some examples, the cache size required by TSN standards is underutilized. For example, the “IEEE Standard for Local and Metropolitan Area Network—Bridges and Bridged Networks,” in IEEE Std 802.1Q-2018 (Revision of IEEE Std 802.1Q-2014), vol., no., pp. 1-1993, 6 Jul. 2018 (referred to hereinafter as “the IEEE 802.1Q standard”) defines eight traffic classes (e.g., TC0-TC7) for all data streams. However, each traffic class is subject to different parameters (e.g., quality of service (QoS)). In industrial applications, high priority, hard real-time, traffic is classified as TC7-TC5 and the data of packets of these classes is typically small (e.g., compared to TC4-TC0) and is less than 256 B. Similarly, non-real-time, best effort traffic (e.g., best effort data stream(s)) is classified as TC4-TC0 and the data of packets of these classes is usually between 256 B and 1518 B. As used herein, real-time traffic and/or real-time data stream(s) refers to network traffic associated with a computing application in which success of the computing application is dependent on the logical correctness of the outcome of the computing application as well as whether the outcome of the computing application was provided with a specified time constraint known as a deadline. As used herein, hard real-time traffic and/or hard real-time data stream(s) refers to real-time traffic associated with a computing application where failure to meet a deadline constitutes failure of the computing application. As used herein, best effort traffic and/or best effort data stream(s) refers to network traffic associated with a computing application that does not require an outcome with a specified time constraint.

Examples disclosed herein take advantage of the traffic classes set forth in the IEEE 802.1Q standard to improve (e.g., optimize) the design of cache in a TSN capable device (e.g., a TSN NIC). Accordingly, example methods, apparatus, and/or articles of manufacture disclosed herein reduce the overall cache size in TSN capable devices (e.g., TSN NICs). Because smaller packets can be transmitted more quickly than a device can prefetch data for a subsequent transmission, supporting the line rate at the smallest packet size of a traffic class is difficult. However, theoretically, the sum of cache utilization of all queues cannot exceed the line rate. The example architecture disclosed herein is based on these two principles.

Example methods, apparatus, and articles of manufacture disclosed herein decode network (e.g., data stream) traffic classes, compute cache region sizes, and credit the descriptor cache and the data cache for each queue thereby increasing the overall cache utilization and reducing the overall cache area consumption on die. For descriptor cache, examples disclosed herein allocate more descriptor cache to data streams of traffic classes TC7-TC5 because these data streams include packets with smaller payloads (e.g., compared to TC4-TC0) and therefore require more fetches for descriptors. Conversely, for descriptor cache, examples disclosed herein allocate less descriptor cache to data streams of traffic classes TC4-TC0 because these data streams include packets with larger payloads (e.g., compared to TC7-TC5) and therefore require less fetches for descriptors.

As used herein, “allocate” and variations thereof (e.g., allocation, reallocate, etc.) are defined to mean otherwise establishing a relationship between one or more portions (e.g., discrete, continuous, and/or otherwise) of a first set (e.g., a unit set or otherwise) and one or more other sets or subsets. Allocating can be used to mean assigning, dividing, apportioning, or the like. Thus, in some examples, disclosed methods, apparatus, and/or articles of manufacture allocate portions (e.g., in the form of bits, bytes (B), kilobytes (KB), etc.) of a cache to respective queues of that cache. In some such examples, disclosed methods, apparatus, and/or articles of manufacture allocate a first portion (e.g., 256 B) of descriptor cache to a first queue assigned traffic class TC7 and allocate a second portion (e.g., 64 B) of descriptor cache to a second queue assigned traffic class TC0. In additional or alternative examples, disclosed methods, apparatus, and/or articles of manufacture allocate percentages (e.g., 4%, 5%, 26%, etc.) of a cache to respective queues of that cache. In other examples, disclosed methods, apparatus, and/or articles of manufacture allocate one or more portions of a cache to one or more groups of queues and allocate sub-portions of the allocated cache to ones of the groups of queues. For example, disclosed methods, apparatus, and/or articles of manufacture allocate a first portion (e.g., 75%) of a (e.g., 2 KB) descriptor cache to queues assigned traffic classes TC7-TC5 and allocate a second portion (e.g., 25%) of the (e.g., 2 KB) descriptor cache to queues assigned traffic classes TC4-TC0. In such an example, of the first portion (e.g., 1.5 KB) of the descriptor cache allocated to the queues assigned traffic classes TC7-TCS, disclosed methods, apparatus, and/or articles of manufacture allocate a first sub-portion (e.g., 500 B) to the queue assigned traffic class TC7, a second sub-portion (e.g., 500 B) to the queue assigned traffic class TC6, and a third sub-portion (e.g., 500 B) to the queue assigned traffic class TCS. Additionally, in such an example, of the second portion (e.g., 0.5 KB) of the descriptor cache allocated to the queues assigned traffic classes TC4-TC0, disclosed methods, apparatus, and/or articles of manufacture allocate a first sub-portion (e.g., 100 B) to the queue assigned traffic class TC4, a second sub-portion (e.g., 100 B) to the queue assigned traffic class TC3, a third sub-portion (e.g., 100 B) to the queue assigned traffic class TC2, a fourth sub-portion (e.g., 100 B) to the queue assigned traffic class TC1, and a fifth sub-portion (e.g., 100 B) to the queue assigned traffic class TC0. As should be clear, disclosed methods, apparatus, and/or articles of manufacture may allocate cache as the number of bits assigned to a queue and/or group of queues, the percentage of available cache assigned to a queue and/or group of queues, and/or any combination thereof.

Additionally, for data cache, examples disclosed herein allocate less data cache to data streams of traffic classes TC7-TC5 because these data streams include packets with smaller payloads (e.g., compared to TC4-TC0). Additionally, because data streams of traffic classes TC7-TC5 are time sensitive (e.g., hard real-time traffic) examples disclosed herein transmit the payloads without storing them in cut-through mode. As used herein, cut-through mode refers to packet switching in which a device begins forwarding a packet before the whole packet has been received. Thus, less cache is adequate for hard real-time traffic (e.g., data streams). For data cache, examples disclosed herein allocate more data cache to data streams of traffic classes TC4-TC0 because these data streams include packets with larger payloads (e.g., compared to TC7-TC5) are of lower priority (e.g., compared to TC7-TC5).

In existing technologies, the descriptor cache size is computed based on minimum packet size supported by the TSN standard and is statically allocated for each queue regardless of traffic class assigned to that queue. For example, existing TSN NICs support 16 descriptors for each transmit queue and each receive queue of the descriptor cache. In such an example, because enhanced descriptors require 8 double words (32 B), existing TSN NICs require 4 kilobytes (KB) (e.g., 32×16×8) for the cache size for the transmit queues. Similarly, existing TSN NICs require 4 KB (e.g., 32×16×8) for the cache size for the receive queues (e.g., 8 KB total). For traffic classes that include larger payloads (e.g., as compared to other traffic classes), much of descriptor cache remains unused. For such traffic classes, the descriptor cache remains unused because, to sustain a line rate, not much more than one packet can be stored for packets with large payloads. Thus, the descriptor cache is under-utilized.

Some existing TSN NICs are designed for a link speed of 2.5 Gbps. These existing TSN NIC designs are not scalable, especially as target link speeds approach 10 Gbps. For example, existing TSN MC designs would require larger cache to sustain the line rate for smaller packets. In such an example, existing TSN NICs would require large die area and increase the cost of products including existing TSN MC designs. Additionally, in such an example, for the data cache, each queue of existing TSN NICs is designed to support two maximum payloads of 1518 B each. This allocation of cache is likely too much due to the minimum payload of 64 B each. Existing TSN NIC designs include 4 KB for the data cache for each transmit queue and each receive queue. Therefore, an existing TSN NIC with 8 transmit queues and 8 receive queues, requires 64 KB for the data cache.

Another approach is to remove static individual cache boundaries for each queue. For example, the entire cache may be usable for any queue. Though on the surface this approach appears to solve the issues that befall statically bounded queues, this approach is problematic if any queue and/or combination of queues can over utilize the cache thereby leading to starvation of the cache for other queues (e.g., real-time queues). Thus, this approach is not suited for hard real-time applications because starving a prefetch of descriptors or payload for a queue assigned to hard-real-time traffic will impact timely transmission of a packet and thus increases the overall transmit packet latency.

The above mentioned two approaches to cache allocation (e.g., static cache boundaries and no cache boundaries) have severe limitations. The first approach of fixed size caches with static allocation requires an impractical amount of area on chip, resulting in negative impacts, especially for NICs that support 10 Gbps link speeds. The second approach of cache with no queue boundaries leads to starvation of cache for hard real-time queues because one or more data streams can over utilize the cache by prefetching too many descriptors thereby leading to starvation of cache for other queues (e.g., those assigned to hard real-time traffic). Examples disclosed herein solve the issues associated with at least these two approaches by dynamically adjusting cache boundaries per queue based on the traffic class assigned to the queue. Because examples disclosed herein adjust cache boundaries per queue based on the traffic class assigned to the queue, examples disclosed herein reduce the overall cache size to implement a TSN NIC.

Example methods, apparatus, and articles of manufacture disclosed herein efficiently utilize the available cache by dynamically allocating the cache that is needed for a given data stream based on the traffic class of the data streams mapped to the one or more queues of the cache. Unlike existing approaches which allocate fixed size to the queues, examples disclosed herein partition the cache across all the queues based on the traffic class assigned to a queue. Therefore, the overall cache is utilized more optimally and eliminates cache redundancy. Additionally, examples disclosed herein reduce the die area to implement NIC, the power and die cost for chip manufacturers, and for customers.

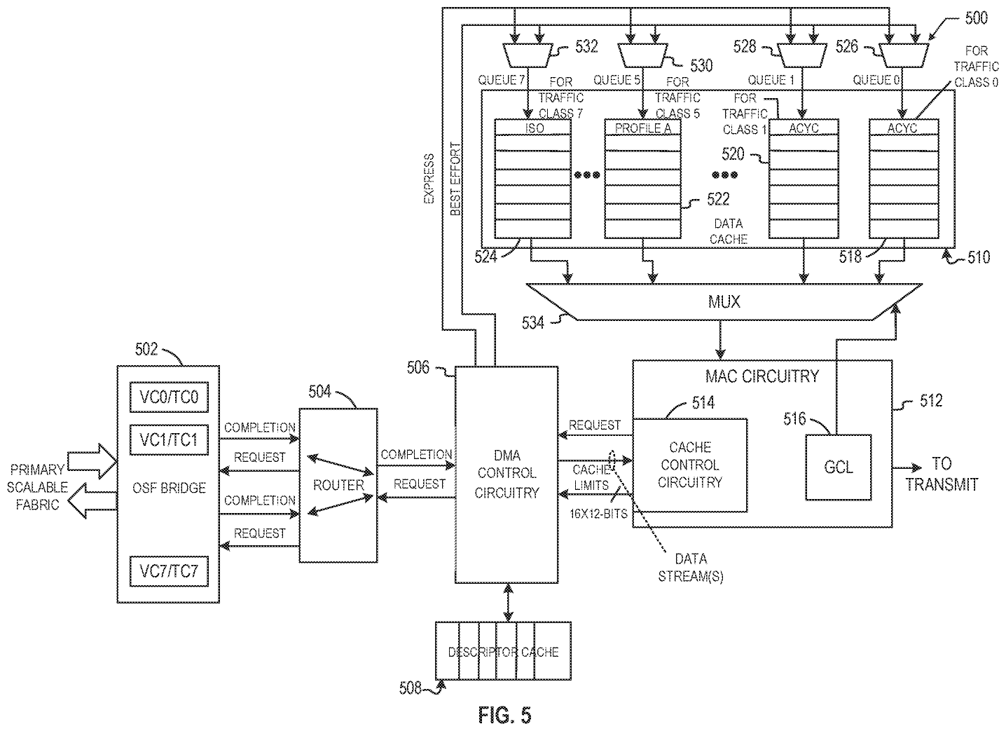

FIG. 5 is a block diagram of example network interface circuitry (NIC) 500 that may be implemented in one or more edge devices and/or one or more IT/OT devices of FIGS. 1, 2, 3, and/or 4. In the example of FIG. 5, the NIC 500 includes an example on-chip system fabric (OSF) bridge 502, an example router 504, and example direct memory access (DMA) control circuitry 506. In the example of FIG. 5, the OSF bridge 502 is implemented by one or more hardware switches that have been virtualized into one or more logical switches. In the example of FIG. 5, the OSF bridge 502 serves as an interface between an example primary scalable fabric (PSF) that connects to other portions of an SoC and the router 504. The example OSF bridge 502 transmits one or more completion signals to and/or receives one or more request signals from the router 504. In the example of FIG. 5, request signals correspond to requests for the DMA control circuitry 506 to prefetch data and completion signals correspond to a return of the prefetched data to the DMA control circuitry 506. Example completion and request signals are routed based on one or more virtual classes (VCs) and corresponding one or more traffic classes (TCs) assigned to data streams. For example, the IEEE 802.1Q standard defines eight traffic classes to which data stream must map. In examples disclosed herein, time sensitive hard real-time data streams are mapped to TC7-TC5 and best effort data streams are mapped to TC4-TC0.

In the illustrated example of FIG. 5, the example router 504 serves as an interconnect between the OSF bridge 502 and the DMA control circuitry 506. In the example of FIG. 5, the router 504 is implemented by one or more logic circuits. In additional or alternative examples, the router 504 is implemented by processor circuitry, analog circuit(s), digital circuit(s), logic circuit(s), programmable microprocessor(s), programmable microcontroller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)) such as Field Programmable Gate Array(s) (FPGA(s)). In the example of FIG. 5, the router 504 routes completion and request signals to and/or from the DMA control circuitry 506.

In the illustrated example of FIG. 5, the DMA control circuitry 506 is implemented by one or more logic circuits. In additional or alternative examples, the DMA control circuitry 506 is implemented by processor circuitry, analog circuit(s), digital circuit(s), logic circuit(s), programmable processor(s), programmable controller(s), GPU(s), DSP(s), ASIC(s), PLD(s) and/or FPLD(s) such as FPGAs. In the example of FIG. 5, the DMA control circuitry 506 fetches data to load into an example descriptor cache 508 (e.g., L1, L2, L3, etc.) and/or an example data cache 510 (e.g., L1, L2, L3, etc.). In the example of FIG. 5, the descriptor cache 508 is implemented by 4 KB of cache. In the example of FIG. 5, the data cache 510 is implemented by 16 KB of cache.

In some examples, the NIC 500 includes one or more means for storing. For example, the one or more means for storing may be implemented by the descriptor cache 508 and/or the data cache 510. For example, the descriptor cache 508 may implement first means for storing and the data cache 510 may implement second means for storing. In some examples, the descriptor cache 508 and the data cache 510 may implement means for storing. In additional or alternative examples, the descriptor cache 508 implements means for storing one or more descriptors and the data cache 510 implements means for storing data. In some examples, the descriptor cache 508 and/or the data cache 510 may be implemented by one or more registers, a main memory, a volatile memory (e.g., Synchronous Dynamic Random-Access Memory (SDRAM), Dynamic Random-Access Memory (DRAM), RAMBUS® Dynamic Random-Access Memory (RDRAM®), and/or any other type of RAM device), and/or a non-volatile memory (e.g., flash memory and/or any other desired type of memory device).

In other examples, the cache control circuitry 514 is implemented by other hardware logic circuitry, hardware implemented state machines, and/or any other combination of hardware, software, and/or firmware. For example, the cache control circuitry 514 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrated example of FIG. 5, the DMA control circuitry 506 additionally adjusts the allocation of the descriptor cache 508 and/or the data cache 510 based on one or more request signals and/or one or more cache limit signals received from an example media access control (MAC) circuitry 512. In the example of FIG. 5, the MAC circuitry 512 is implemented by one or more logic circuits. In additional or alternative examples, the DMA control circuitry 506 is implemented by processor circuitry, analog circuit(s), digital circuit(s), logic circuit(s), programmable processor(s), programmable controller(s), GPU(s), DSP(s), ASIC(s), PLD(s) and/or FPLD(s) such as FPGAs.

In the illustrated example of FIG. 5, the MAC circuitry 512 includes example cache control circuitry 514 and example gate control logic (GCL) circuitry 516. In the example of FIG. 5, the cache control circuitry 514 generates the one or more request signals and/or the one or more cache limit signals. Additionally, the cache control circuitry 514 processes one or more data streams retrieved by the DMA control circuitry 506. In the example of FIG. 5, the cache control circuitry 514 is implemented by one or more special purpose electrical circuits structured to perform specific operation(s) and including one or more semiconductor-based logic devices (e.g., electrical hardware implemented by one or more transistors). In some examples, the cache control circuitry 514 is implemented by processor circuitry, analog circuit(s) digital circuit(s), logic circuit(s), programmable processor(s), programmable controller(s), GPU(s), DSP(s), ASIC(s), PLD(s) and/or FPLD(s) such as FPGAs.

In the illustrated example of FIG. 5, the example NIC 500 illustrates the implementation of the cache control circuitry 514 for a transmitter. A receiver implementing examples disclosed herein will have NIC having an opposite approach to that of the NIC 500. For example, a receiver implementing examples disclosed herein includes cache control circuitry, variable data cache, and variable descriptor cache. In such an example receiver, the cache control circuitry dynamically varies the allocation of the data cache to each queue based on the traffic class assigned to the queue. Additionally, in such a receiver, the cache control circuitry dynamically varies the allocation of the descriptor cache to each queue based on the traffic class assigned to the queue. Accordingly, for transmission and reception, the total descriptor cache size when implementing examples disclosed herein is 8 KB (e.g., 4 KB for the transmitter and 4 KB for the receiver). Additionally, for transmission and reception, the total data cache size when implementing examples disclosed herein is 32 KB (e.g., 16 KB for the transmitter and 16 KB for the receiver).

In the illustrated example of FIG. 5, the cache control circuitry 514 leverages the traffic class mapping of data packets under the IEEE 802.1Q standard. For example, in industrial applications, hard real-time packets data payload is typically smaller than 256 B and the non-real-time data is often bigger than 256 B. In the example of FIG. 5, the cache control circuitry 514 computes cache boundaries and allocates cache to queues in the descriptor cache 508 and/or the data cache 510 based on the traffic class of data streams that are mapped to each queue. In examples disclosed herein, the cache control circuitry 514 allocates cache to queues on a per application basis. For example, before an application executes, the cache control circuitry 514 allocates the cache for that application. Example application include controlling a motor (e.g., including more descriptors but smaller data packets), monitoring video (e.g., video data is mapped to TC0 while control is mapped to TC7), and IT/OT applications (e.g., data packets are mapped to TC0 while control packets are mapped to TC7). Depending on the type of traffic class associated with each data stream, the cache control circuitry 514 dynamically allocates cache to the corresponding queue for optimal utilization of the cache.

In the illustrated example of FIG. 5, the cache control circuitry 514 sends (e.g., transmits) information indicative of the allocation of each transmit queue and receive queue of the descriptor cache 508 to the DMA control circuitry 506 via the one or more cache limit signals. In the example of FIG. 5, the cache control circuitry 514 transmits the one or more cache limit signals as sixteen twelve-bit signals. In the example of FIG. 5, when the tail pointer for a given transfer buffer ring (TRB) is advanced by the application, the DMA control circuitry 506 starts prefetching the descriptors as long as there is space in the descriptor cache 508 which is allocated according to the one or more cache limit signals sent by the cache control circuitry 514. In this manner, no single data stream over-utilizes or under-utilizes the descriptor cache 508. The cache control circuitry 514 continually monitors the data streams and corresponding traffic classes. In some examples, the cache control circuitry 514 allocates credits to the queues of the descriptor cache 508 and the data cache 510. For example, the cache control circuitry 514 assigns more credits to the queues with smaller packets and assigns less credits to the queues with larger packets. In such examples, the cache control circuitry 514 monitors and manages the credits. For the credit-based approach, the cache control circuitry 514 resizes (e.g., reallocates) the cache based on the credits assigned to each traffic class. For example, for traffic classes that are more utilized, the cache control circuitry 514 assigns more credits whereas for traffic classes that are less utilized, the cache control circuitry 514 assign less credits.

In the illustrated example of FIG. 5, the cache control circuitry 514 computes cache boundaries and allocates cache to queues in the data cache 510 based on the traffic class of data streams that are mapped to respective queues. For example, the data cache 510 includes eight queues of which an example first queue 518, an example second queue 520, an example sixth queue 522, and an example eighth queue 524 are illustrated. In the example of FIG. 5, TC0 is mapped to the first queue 518, TC1 is mapped to the second queue 520, TC5 is mapped to the sixth queue 522, and TC7 is mapped to the eighth queue 524. In the example of FIG. 5, the cache control circuitry 514 sends (e.g., transmits) information indicative of the allocation of each transmit queue and each receive queue of the data cache 510 to the DMA control circuitry 506 via the one or more data request signals.

In the example of FIG. 5, once the DMA control circuitry 506 prefetches the descriptors, the MAC circuitry 512 (e.g., the cache control circuitry 514) parses the descriptors and generates a data fetch request to the DMA control circuitry 506. The scheduler within the MAC circuitry 512 performs arbitration among the available descriptors and generates one or more data fetch requests to the DMA control circuitry 506 depending on various criteria such as that specified by the “IEEE Standard for Local and metropolitan area networks—Bridges and Bridged Networks—Amendment 25: Enhancements for Scheduled Traffic,” in IEEE Std 802.1Qbv-2015 (Amendment to IEEE Std 802.1Q-2014 as amended by IEEE Std 802.1Qca-2015, IEEE Std 802.1Qcd-2015, and IEEE Std 802.1Q-2014/Cor 1-2015), vol., no., pp. 1-5′7, 18 March 2016 (referred to hereinafter as “the IEEE 802.1Qbv standard”) and/or the “IEEE Standard for Local and Metropolitan Area Networks—Virtual Bridged Local Area Networks Amendment 12: Forwarding and Queuing Enhancements for Time-Sensitive Streams,” in IEEE Std 802.1Qav-2009 (Amendment to IEEE Std 802.1Q-2005), vol., no., pp. C1-72, 5 Jan. 2010 (referred to hereinafter as “the IEEE 802.1Qav standard”). For example, the scheduler within the MAC circuitry 512 performs arbitration among the available descriptors and generates a data fetch request to the DMA control circuitry 506 depending on the traffic class priority, launch time specified in the gate control list (e.g., for the IEEE 802.1Qbv standard), in the descriptor (e.g., for time based scheduling), the available credits (e.g., for the IEEE 802.1Qav standard) and/or based on the available cache space. In time based scheduling examples, the GCL circuitry 516 implements time based control to select which queue to prioritize.

In the example of FIG. 5, after performing a prefetch operation, the DMA control circuitry 506 loads data packets into the first queue 518, the second queue 520, the sixth queue 522, and the eighth queue 524 via an example first multiplexer 526, an example second multiplexer, an example sixth multiplexer 530, and example eighth multiplexer 532, respectively. The DMA control circuitry 506 may load hard real-time data via an express memory path which separate from a best effort memory path with which the DMA control circuitry 506 may load best effort data. Based on the scheduling performed, the MAC circuitry 512 (e.g., the GCL circuitry 516) selects an example multiplexer 534 and forwards the selected data packets to the transmitter of the SoC to be transmitted to another device.

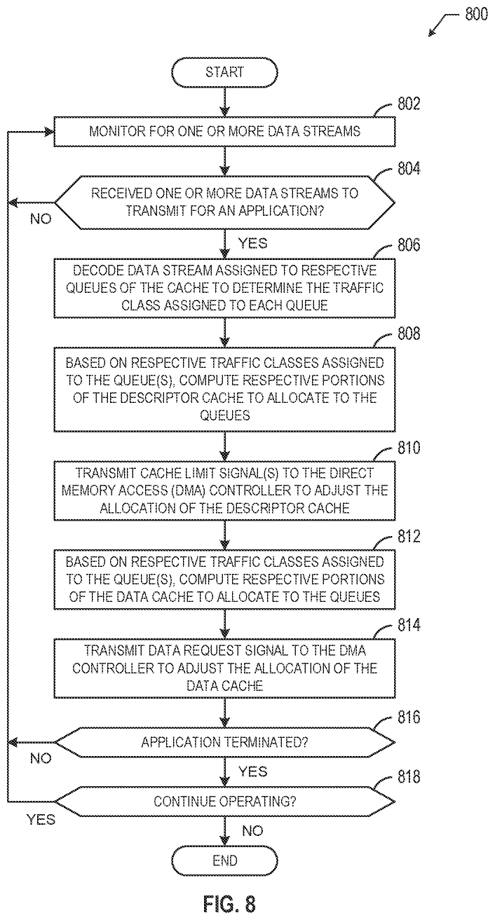

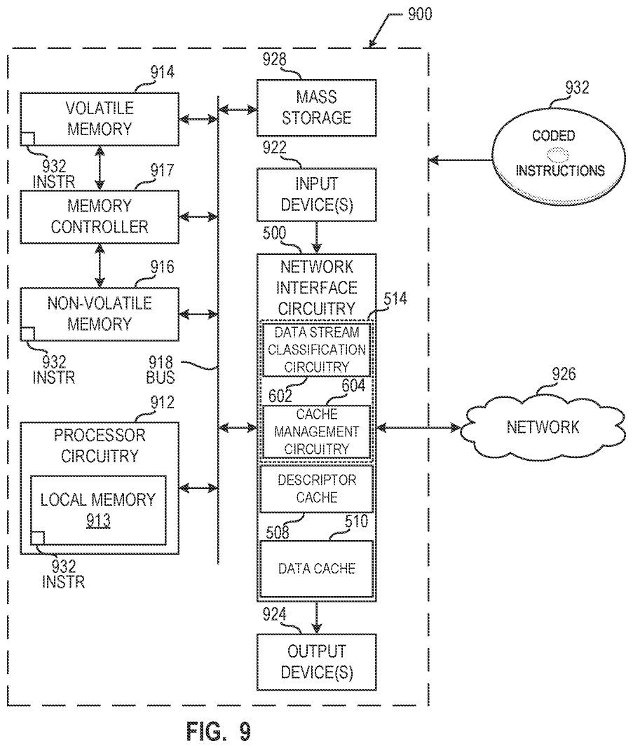

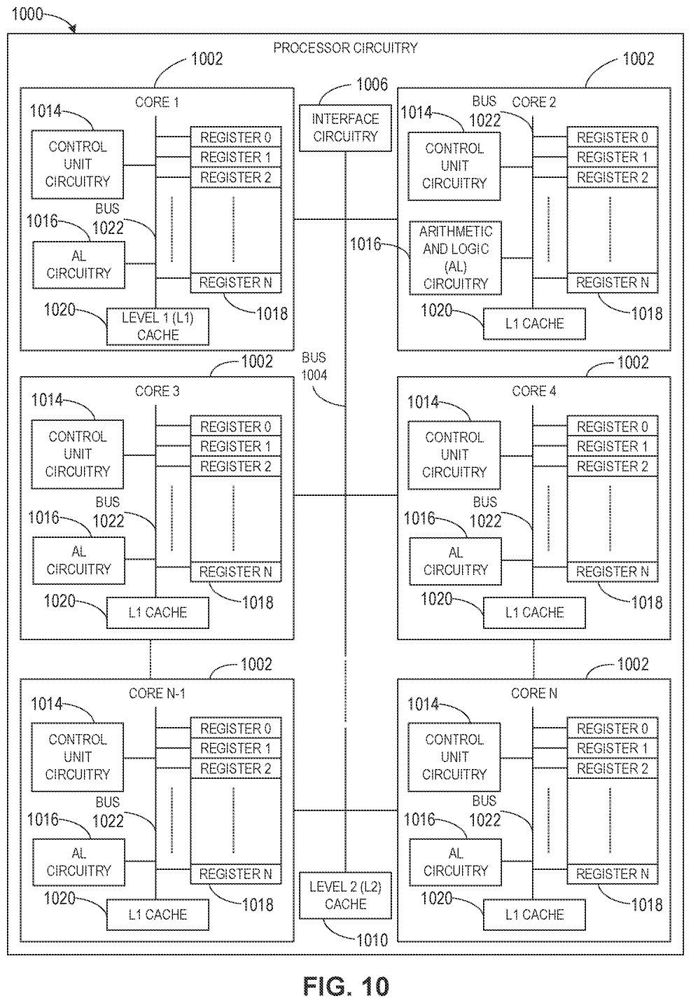

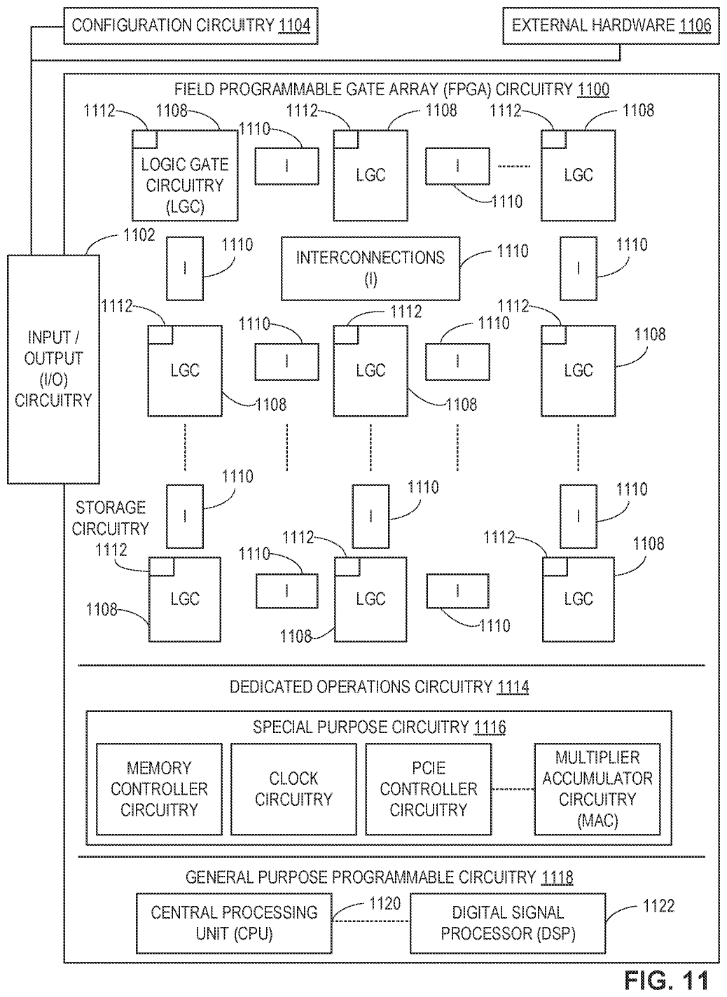

In some examples, the NIC 500 includes means for controlling cache. For example, the means for controlling cache may be implemented by cache control circuitry 514. In some examples, the cache control circuitry 514 may be implemented by machine executable instructions such as that implemented by at least blocks 802, 804, 806, 808, 810, 812, 814, 816, and 818 of FIG. 8 executed and/or instantiated by processor circuitry, which may be implemented by the example processor circuitry 912 of FIG. 9, the example microprocessor 1000 of FIG. 10, and/or the example Field Programmable Gate Array (FPGA) circuitry 1100 of FIG. 11. In other examples, the cache control circuitry 514 is implemented by other hardware logic circuitry, hardware implemented state machines, and/or any other combination of hardware, software, and/or firmware. For example, the cache control circuitry 514 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

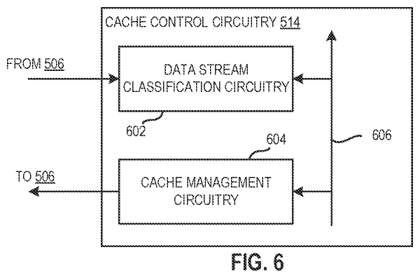

FIG. 6 is a block diagram illustrating an example implementation of the example cache control circuitry 514 of FIG. 5. In the example of FIG. 6, the cache control circuitry 514 includes example data stream classification circuitry 602 and example cache management circuitry 604. In the example of FIG. 6, any of the data stream classification circuitry 602 and/or the cache management circuitry 604 can communicate via an example communication bus 606. In examples disclosed herein, the communication bus 606 may be implemented using any suitable wired and/or wireless communication. In additional or alternative examples, the communication bus 606 includes software, machine-readable instructions, and/or communication protocols by which information is communicated among the data stream classification circuitry 602 and/or the cache management circuitry 604.

In the illustrated example of FIG. 6, the data stream classification circuitry 602 is implemented by one or more special purpose electrical circuits structured to perform specific operation(s) and including one or more semiconductor-based logic devices (e.g., electrical hardware implemented by one or more transistors). In some examples, the data stream classification circuitry 602 is implemented by processor circuitry, analog circuit(s) digital circuit(s), logic circuit(s), programmable processor(s), programmable controller(s), GPU(s), DSP(s), ASIC(s), PLD(s) and/or FPLD(s) such as FPGAs. In the example of FIG. 6, the data stream classification circuitry 602 monitors the DMA control circuitry 506 for one or more data streams. In response to obtaining (e.g., accessing, receiving, etc.) one or more data streams from an application, the data stream classification circuitry 602 decodes the one or more data streams assigned to respective queues of the cache (e.g., the descriptor cache 508 and/or the data cache 510) to determine the traffic class assigned to each queue. Additionally or alternatively, the data stream classification circuitry 602 determines whether the application that requested transmission of the one or more data streams has terminated.

In some examples, the cache control circuitry 514 includes means for classifying one or more data streams. For example, the means for classifying one or more data streams may be implemented by the data stream classification circuitry 602. In some examples, the data stream classification circuitry 602 may be implemented by machine executable instructions such as that implemented by at least blocks 802, 804, 806, 816, and 818 of FIG. 8 executed and/or instantiated by processor circuitry, which may be implemented by the example processor circuitry 912 of FIG. 9, the example microprocessor 1000 of FIG. 10, and/or the example Field Programmable Gate Array (FPGA) circuitry 1100 of FIG. 11. In other examples, the data stream classification circuitry 602 is implemented by other hardware logic circuitry, hardware implemented state machines, and/or any other combination of hardware, software, and/or firmware. For example, the data stream classification circuitry 602 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrated example of FIG. 6, the cache management circuitry 604 is implemented by one or more special purpose electrical circuits structured to perform specific operation(s) and including one or more semiconductor-based logic devices (e.g., electrical hardware implemented by one or more transistors). In some examples, the cache management circuitry 604 is implemented by processor circuitry, analog circuit(s), digital circuit(s), logic circuit(s), programmable processor(s), programmable controller(s), GPU(s), DSP(s), ASIC(s), PLD(s) and/or FPLD(s) such as FPGAs. In the example of FIG. 6, based on the respective traffic classes assigned to the one or more queues of the descriptor cache 508, the cache management circuitry 604 computes respective portions of descriptor cache 508 to allocate to the one or more queues. For example, the cache management circuitry 604 allocates more of the descriptor cache 508 to queues mapped to traffic classes TC7-TC5 because data streams assigned to these queues carry smaller payload data. Conversely, the cache management circuitry 604 allocates less of the descriptor cache 508 to queues mapped to traffic classes TC4-TC0 because data streams assigned to these queues carry larger payload data. The example cache management circuitry 604 additionally transmits one or more cache limit signals to the DMA control circuitry 506 to adjust the allocation of the descriptor cache 508.

In the illustrated example of FIG. 6, based on the respective traffic classes assigned to the one or more queues of the data cache 510, the cache management circuitry 604 computes respective portions of data cache 510 to allocate to the one or more queues. For example, the cache management circuitry 604 allocates more of the data cache 510 to queues mapped to high priority traffic classes (e.g., TC7-TC5). Conversely, the cache management circuitry 604 allocates less of the data cache 510 to queues mapped to low priority traffic classes (e.g., TC4-TC0). The example cache management circuitry 604 additionally transmits one or more data request signals to the DMA control circuitry 506 to adjust the allocation of the data cache 510.

For example, descriptor packets are typically the same size (e.g., bits) regardless of the size of the data packet. As such, the cache management circuitry 604 allocates more of the descriptor cache 508 to traffic classes that include smaller data packets (e.g., traffic classes that are transmitted more frequently, TC7-TCS, etc.) to increase the number of data packets in the data cache 510 thereby offsetting latencies that would otherwise occur in a statically bounded cache. Similarly, the cache management circuitry 604 allocates less of the descriptor cache 508 to traffic classes that include larger data packets (e.g., traffic classes that are transmitted less frequently, TC4-TC0, etc.) to decrease the number of data packets in the data cache 510 because less data packets of these traffic classes will consume more of the data cache 510 as compared to traffic classes that includes smaller data packets.

In some examples, the cache control circuitry 514 includes means for managing one or more means for storing. For example, the means for managing the one or more means for storing may be implemented by the cache management circuitry 604. In some examples, the cache management circuitry 604 may be implemented by machine executable instructions such as that implemented by at least blocks 808, 810, 812, and 814 of FIG. 8 executed and/or instantiated by processor circuitry, which may be implemented by the example processor circuitry 912 of FIG. 9, the example microprocessor1000 of FIG. 10, and/or the example Field Programmable Gate Array (FPGA) circuitry 1100 if FIG. 11. In other examples, the cache management circuitry 604 is implemented by other hardware logic circuitry, hardware implemented state machines, and/or any other combination of hardware, software, and/or firmware. For example, the cache management circuitry 604 may be implemented by at least one or more hardware circuitry (e.g., processor circuitry, discrete and/or integrated analog and/or digital circuitry, an FPGA, an Application Specific Integrated Circuit (ASIC), a comparator, an operational-amplifier(op-amp), a logic circuit, etc.) structured to perform the corresponding operations without executing software or firmware, but other structures are likewise appropriate.

Although FIGS. 5 and 6 illustrate and describe the cache control circuitry 514 as one or more special purpose electrical circuits structured to perform specific operation(s) and including one or more semiconductor-based logic devices (e.g., electrical hardware implemented by one or more transistors), in other examples, the cache control circuitry 514 can be implemented by any other combination of hardware, software, and/or firmware. For example, the cache control circuitry 514 can be implemented by general purpose processor circuitry, such as the example processor circuitry 912 of FIG. 9, the example microprocessor 1000 of FIG. 10, and/or the example Field Programmable Gate Array (FPGA) circuitry 1100 of FIG. 11, which may be programmed to execute and/or instantiate machine-readable instructions and/or operations (e.g., machine-readable instructions corresponding to instructions) such as the machine-readable instructions and/or operations 800 of FIG. 8. In some such examples, the instructions cause processor circuitry to perform one or more operations corresponding to the machine-readable instructions and/or operations (e.g., the machine-readable instructions and/or operations 800 of FIG. 8).

In some examples, the microprocessor 1000 (e.g., multi-core hardware circuitry including a CPU, a DSP, a GPU, an XPU, etc.) includes one or more cores that may operate independently or cooperatively to execute machine-readable instructions that may correspond to at least some of the machine-readable instructions and/or operations 800 of FIG. 8. For example, the microprocessor 1000, executing the machine-readable instructions and/or operations 800, decodes one or more data streams assigned to one or more queues of the descriptor cache 508 and/or the data cache 510 to determine one or more traffic classes assigned to the one or more queues. Additionally or alternatively, the microprocessor 1000, executing the machine-readable instructions and/or operations 800, allocates one or more portions of the descriptor cache 508 and/or the data cache 510 to the one or more queues based on the one or more traffic classes assigned thereto. In some examples, the microprocessor 1000, executing the machine-readable instructions and/or operations 800, transmits one or more signal to the DMA control circuitry 506 to set one or more registers of the DMA control circuitry 506 to adjust allocation of the descriptor cache 508 and/or the data cache 510.

In additional or alternative examples, the FPGA circuitry 1100 is configured to implement the cache control circuitry 514 of FIG. 5. For example, the FPGA circuitry 1100 is configured to instantiate one or more operations that may correspond to at least some of the machine-readable instructions and/or operations 800 of FIG. 8. For example, the FPGA circuitry 1100, when instantiating the machine-readable instructions and/or operations 800, decodes one or more data streams assigned to one or more queues of the descriptor cache 508 and/or the data cache 510 to determine one or more traffic classes assigned to the one or more queues. Additionally or alternatively, the FPGA circuitry 1100, when instantiating the machine-readable instructions and/or operations 800, allocates one or more portions of the descriptor cache 508 and/or the data cache 510 to the one or more queues based on the one or more traffic classes assigned thereto. In some examples, the FPGA circuitry 1100, when instantiating the machine-readable instructions and/or operations 800, transmits one or more signal to the DMA control circuitry 506 to set one or more registers of the DMA control circuitry 506 to adjust allocation of the descriptor cache 508 and/or the data cache 510.

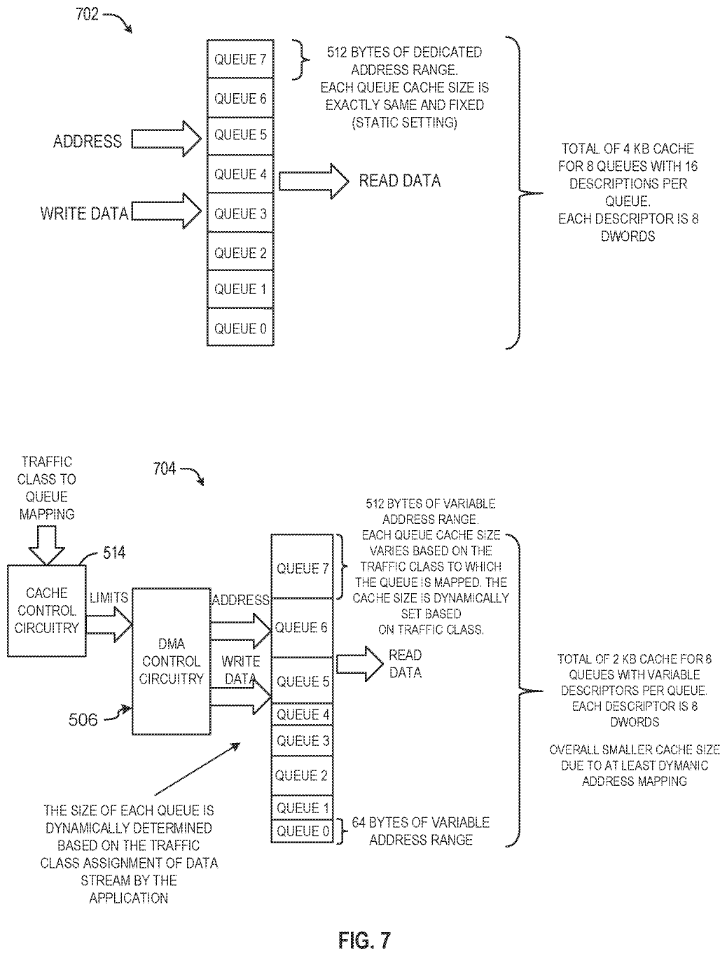

FIG. 7 is an example graphical illustration 700 demonstrating at least one advantage of examples disclosed herein as compared to existing technology. The graphical illustration 700 includes an example representation of existing cache 702 and an example representation of example cache 704. The example representation of the example cache 704 illustrates example interactions between the cache control circuitry 514 of FIGS. 5 and/or 6, the DMA control circuitry 506 of FIG. 5, and the example cache 704.

In the illustrated example of FIG. 7, the existing cache 702 illustrates an example of fixed cache region partitioning while the example cache 704 illustrates disclosed variable cache region partitioning. As shown in FIG. 7, in the fixed cache region partitioning, the eight queues of the existing cache 702 are each allocated equally sized dedicated regions of the existing cache 702. For example, each queue in the existing cache 702 is allocated 512 B of dedicated address range that is fixed and cannot change. Accordingly, the existing cache 702 requires 4 KB for eight queues that can store sixteen descriptors per queue. In the example of FIG. 7, each descriptor is eight double words (DWords) or 32 B. However, as explained above, the existing cache 702 is subject to underutilization and is not scalable because of the large silicon area required with increasing link speed.

In the illustrated example of FIG. 7, the example cache 704 implements active cache management as the cache control circuitry 514 computes the cache credits and region limits for each queue dynamically based on the traffic class assigned for one or more data streams by an application requesting transmission of the one or more data streams. In other words, the cache control circuitry 514 computes the cache credits and region limits for each queue dynamically based on the traffic class to queue mapping (e.g., the type of data stream associated with each queue). For example, the cache control circuitry 514 can vary the address range allocated to each queue of the example cache 704 between 512 B and 64 B based on the traffic class mapped to the queue.

In the illustrated example of FIG. 7, the cache control circuitry 514 dynamically allocates the example cache 704 to queues based on traffic class. For example, the cache control circuitry 514 allocates credits to the queues of the example cache 704 based latency of a data stream assigned to the queues. For example, the cache control circuitry 514 assigns more credits to a queue mapped to a low latency data stream as compared to another queue mapped to a high latency data stream. As a result of the dynamic address mapping disclosed herein, the example cache 704 is more efficient and increases the cache utilization thereby reducing the overall cache size. Thus, the dynamic address mapping disclosed herein reduces the overall size of cache that is implemented in NICs and/or other devices.

While an example manner of implementing the cache control circuitry 514 of FIG. 5 is illustrated in FIG. 6, one or more of the elements, processes, and/or devices illustrated in FIG. 6 may be combined, divided, re-arranged, omitted, eliminated, and/or implemented in any other way. Further, the example data stream classification circuitry 602, the example cache management circuitry 604, and/or, more generally, the example cache control circuitry 514 of FIG. 6, may be implemented by hardware, software, firmware, and/or any combination of hardware, software, and/or firmware. Thus, for example, any of the example data stream classification circuitry 602, the example cache management circuitry 604, and/or, more generally, the example cache control circuitry 514 of FIG. 6, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example data stream classification circuitry 602, the example cache management circuitry 604, and/or, more generally, the example cache control circuitry 514 of FIG. 6 is/are hereby expressly defined to include a non-transitory computer readable storage device or storage disk such as a memory, a digital versatile disk (DVD), a compact disk (CD), a Blu-ray disk, etc., including the software and/or firmware. Further still, the example cache control circuitry 514 of FIGS. 5 and/or 6 may include one or more elements, processes, and/or devices in addition to, or instead of, those illustrated in FIG. 6, and/or may include more than one of any or all of the illustrated elements, processes, and devices.

A flowchart representative of example hardware logic circuitry, machine-readable instructions, hardware implemented state machines, and/or any combination thereof for implementing the cache control circuitry 514 of FIGS. 5 and/or 6 is shown in FIG. 8. The machine-readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or non-volatile memory (e.g., FLASH memory, an HDD, etc.) associated with processor circuitry located in one or more hardware device, but the entire program and/or parts thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 8, many other methods of implementing the example cache control circuitry 514 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 8 may be implemented using executable instructions (e.g., computer and/or machine-readable instructions) stored on one or more non-transitory computer and/or machine-readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine-readable instructions and/or example operations 800 that may be executed and/or instantiated by processor circuitry to implement the example cache control circuitry 514 of FIGS. 5 and/or 6. The machine-readable instructions and/or operations 800 of FIG. 8 begin at bock 802 where the data stream classification circuitry 602 monitors for one or more data streams. For example, at block 802, the data stream classification circuitry 602 monitors the DMA control circuitry 506 for one or more data streams. At block 804, the data stream classification circuitry 602 determines whether the data stream classification circuitry 602 has received one or more data streams to transmit for an application.

In the illustrated example of FIG. 8, in response to the data stream classification circuitry 602 determining that one or more data streams have been received from an application (block 804: YES), the machine-readable instructions and/or operations 800 proceed to block 806. In response to the data stream classification circuitry 602 determining that one or more data streams have not been received from an application (block 804: NO), the machine-readable instructions and/or operations 800 return to block 802. At block 806, the data stream classification circuitry 602 decodes the one or more data streams assigned to respective queues of the cache (e.g., the descriptor cache 508 and/or the data cache 510) to determine the traffic class assigned to each queue.

In the illustrated example of FIG. 8, at block 808, based on the respective traffic classes assigned to the one or more queues of the descriptor cache 508, the cache management circuitry 604 computes respective portions of descriptor cache 508 to allocate to the one or more queues. For example, at block 808, the cache management circuitry 604 allocates more of the descriptor cache 508 to queues mapped to traffic classes TC7-TC5 because data streams assigned to these queues carry smaller data packets. Additionally or alternatively, at block 808, the cache management circuitry 604 allocates less of the descriptor cache 508 to queues mapped to traffic classes TC4-TC0 because data streams assigned to these queues carry larger data packets.

In the illustrated example of FIG. 8, at block 810, the cache management circuitry 604 transmits one or more cache limit signals to the DMA control circuitry 506 to adjust the allocation of the descriptor cache 508. At block 812, based on the respective traffic classes assigned to the one or more queues of the data cache 510, the cache management circuitry 604 computes respective portions of data cache 510 to allocate to the one or more queues. For example, at block 812, the cache management circuitry 604 allocates less of the data cache 510 to queues mapped to high priority traffic classes (e.g., TC7-TC5). In additional or alternative examples, at block 812, the cache management circuitry 604 allocates more of the data cache 510 to queues mapped to low priority traffic classes (e.g., TC4-TC0). At block 814, the cache management circuitry 604 transmits one or more data request signals to the DMA control circuitry 506 to adjust the allocation of the data cache 510.

In the illustrated example of FIG. 8, at block 816, the data stream classification circuitry 602 determines whether the application that requested transmission of the one or more data streams has terminated. In response to the data stream classification circuitry 602 determining that the application that requested transmission of the one or more data streams has not terminated (block 816: NO), the machine-readable instructions and/or operations 800 return to block 802. In response to the data stream classification circuitry 602 determining that the application that requested transmission of the one or more data streams has terminated (block 816: YES), the machine-readable instructions and/or operations 800 proceed to block 818.

In the illustrated example of FIG. 8, at block 818, the data stream classification circuitry 602 determines whether to continue operating. For example, a condition that causes the data stream classification circuitry 602 to determine to discontinue operation includes powering off the NIC and/or other device in which the cache control circuitry 514 is implemented. In response to the data stream classification circuitry 602 determining to continue operation (block 818: YES), the machine-readable instructions and/or operations 800 return to block 802. In response to the data stream classification circuitry 602 determining not to continue operation (block 818: NO), the machine-readable instructions and/or operations 800 terminate.

FIG. 9 is a block diagram of an example processor platform 900 including processor circuitry structured to execute and/or instantiate the machine-readable instructions and/or operations of FIG. 8 to implement the cache control circuitry 514 of FIGS. 5 and/or 6. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs, microprocessors, CPUs, GPUs, DSPs, and/or microcontrollers from any desired family or manufacturer. The processor circuitry 912 may be implemented by one or more semiconductor based (e.g., silicon based) devices.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 via a bus 918. The volatile memory 914 may be implemented by Synchronous Dynamic Random-Access Memory (SDRAM), Dynamic Random-Access Memory (DRAM), RAMBUS® Dynamic Random-Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes the example network interface circuitry 500. The network interface circuitry 500 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. In some examples, the network interface circuitry 500 may also be referred to as a host fabric interface (HFI). In the example of FIG. 9, the network interface circuitry 500 is implemented on a separate die from the processor circuitry 912 (e.g., as part of a SoC).

In some examples, the network interface circuitry 500 is implemented on the same die as the processor circuitry 912. In additional or alternative examples, the network interface circuitry 500 is implemented within the same package as the processor circuitry 912. In some examples, the network interface circuitry 500 is implemented in a different package from the package in which the processor circuitry 912 is implemented. For example, the network interface circuitry 500 may be implemented as one or more add-in-boards, daughter cards, network interface cards, controller chips, chipsets, or other devices that may be used by the processor circuitry 912 to connect with another processor platform and/or other device.

In the illustrated example, one or more input devices 922 are connected to the network interface circuitry 500. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the network interface circuitry 500 of the illustrated example. The output devices 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The network interface circuitry 500 of the illustrated example, thus, typically includes a graphics driver card, a graphics driver chip, and/or graphics processor circuitry such as a GPU.

In the illustrated example of FIG. 9, the network interface circuitry 500 implements the descriptor cache 508, the data cache 510, and the example data stream classification circuitry 602, the example cache management circuitry 604, and/or, more generally, the cache control circuitry 514. The network interface circuitry 500 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 932 of FIG. 9 which may be implemented by the machine-readable instructions and/or operations 800 of FIG. 8. The machine executable instructions 932 may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may implement multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine-readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine-readable instructions and/or operations 800 represented by the flowchart of FIG. 8.

The cores 1002 may communicate by an example bus 1004. In some examples, the bus1004 may implement a communication bus to effectuate communication associated with one(s) of the cores 1002. For example, the bus 1004 may implement at least one of an Inter-Integrated Circuit (I2C) bus, a Serial Peripheral Interface (SPI) bus, a PCI bus, or a PCIe bus. Additionally or alternatively, the bus 1004 may implement any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2_cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry 1016 (sometimes referred to as an ALU 1016 and/or arithmetic and logic circuitry 1016), a plurality of registers 1018, the L1 cache 1020, and an example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control data movement (e.g., coordinate data movement) within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The bus 1022 may implement at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. The FPGA circuitry 1100 can be used, for example, to perform operations that could otherwise be performed by the example microprocessor 1000 of FIG. 10 executing corresponding machine-readable instructions. However, once configured, the FPGA circuitry 1100 instantiates the machine-readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine-readable instructions and/or operations 800 represented by the flowchart of FIG. 8 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine-readable instructions and/or operations 800 represented by the flowchart of FIG. 8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowchart of FIG. 8. As such, the FPGA circuitry 1100 may be structured to effectively instantiate some or all of the machine-readable instructions and/or operations 800 of the flowchart of FIG. 8 as dedicated logic circuits to perform the operations corresponding to those software instructions in a dedicated manner analogous to an ASIC. Therefore, the FPGA circuitry 1100 may perform the operations corresponding to the some or all of the machine-readable instructions and/or operations 800 of FIG. 8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware (e.g., external hardware circuitry) 1106. For example, the configuration circuitry 1104 may implement interface circuitry that may obtain machine-readable instructions to configure the FPGA circuitry 1100, or portion(s) thereof. In some such examples, the configuration circuitry 1104 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. As used herein, a model is a set of instructions and/or data that may be ingested, processed, interpreted and/or otherwise manipulated by processor circuitry to produce a result. Often, a model is operated using input data to produce output data in accordance with one or more relationships reflected in the model. The model may be based on training data. In some examples, the external hardware 1106 may implement the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and interconnections 1110 are configurable to instantiate one or more operations that may correspond to at least some of the machine-readable instructions and/or operations 800 of FIG. 8 and/or other desired operations. The logic gate circuitryl108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine-readable instructions and/or operations 800 represented by the flowchart of FIG. 8 may be executed by one or more of the cores 1002 of FIG. 10 and a second portion of the machine-readable instructions and/or operations 800 represented by the flowchart of FIG. 8 may be executed by the FPGA circuitry 1100 of FIG. 11.

In some examples, the processor circuitry 912 of FIG. 9 may be in one or more packages. For example, the microprocessor 1000 of FIG. 10 and/or the FPGA circuitry 1100 of FIG.11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

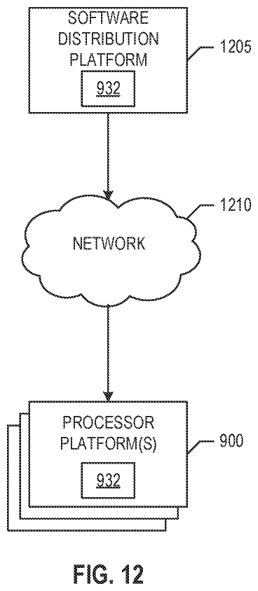

A block diagram illustrating an example software distribution platform 1205 to distribute software such as the example machine-readable instructions 932 of FIG. 9 to hardware devices owned and/or operated by third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine-readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine-readable instructions 932, which may correspond to the example machine-readable instructions and/or operations 800 of FIG. 8, as described above. The one or more servers of the example software distribution platform 1205 are in communication with a network 1210, which may correspond to any one or more of the Internet and/or any of the example the edge cloud 110 described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 932 from the software distribution platform 1205. For example, the software, which may correspond to the example machine-readable instructions and/or operations 800 of FIG. 8, may be downloaded to the example processor platform 900, which is to execute the machine-readable instructions 932 to implement the cache control circuitry 514. In some example, one or more servers of the software distribution platform 1205 periodically offer, transmit, and/or force updates to the software (e.g., the example machine-readable instructions 932 of FIG. 9) to ensure improvements, patches, updates, etc., are distributed and applied to the software at the end user devices.

From the foregoing, it will be appreciated that example systems, methods, apparatus, and articles of manufacture have been disclosed that utilize available cache more efficiently by dynamically sizing the cache regions of each queue based on the traffic class of the data streams mapped to respective queues. Disclosed systems, methods, apparatus, and articles of manufacture improve the efficiency of using a computing device by eliminating cache redundancy thereby reducing overall cache size and saving area, power, and die cost (e.g., capital expenditure) for manufactures and customers. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to dynamically allocate cache are disclosed herein. Further examples and combinations thereof include the following:

Example 1 includes an apparatus comprising a cache having a queue, data stream classification circuitry to decode a data stream assigned to the queue of the cache to determine a traffic class assigned to the queue, and cache management circuitry to based on the traffic class assigned to the queue, allocate a portion of the cache to the queue, and transmit a signal to a memory controller to adjust allocation of the cache.

In Example 2, the subject matter of Example 1 can optionally include that the queue is a first queue, the cache is a first cache, the portion is a first portion, the signal is a first signal, the data stream classification circuitry is to decode the data stream assigned to the first queue of the first cache and a second queue of a second cache to determine the traffic class assigned to the first queue and the second queue, and the cache management circuitry is to based on the traffic class assigned to the second queue, allocate a second portion of the second cache to the second queue, and transmit a second signal to the memory controller to adjust allocation of the second cache.

In Example 3, the subject matter of Examples 1-2 can optionally include that the first cache includes a descriptor cache and the second cache includes a data cache.

In Example 4, the subject matter of Examples 1-3 can optionally include that the cache management circuitry is to allocate the portion of the cache to the queue based on a size of a packet of the traffic class assigned to the queue.

In Example 5, the subject matter of Examples 1-4 can optionally include that the cache management circuitry is to allocate the portion of the cache to the queue based on a priority of the traffic class assigned to the queue.

In Example 6, the subject matter of Examples 1-5 can optionally include that the traffic class was assigned to the queue by an application requesting transmission of the data stream.

In Example 7, the subject matter of Examples 1-6 can optionally include that the application requesting transmission of the data stream is implemented in an information technology/operational technology environment.

Example 8 includes an apparatus comprising a cache including a queue, processor circuitry including one or more of at least one of a central processor unit (CPU), a graphics processing unit (GPU), or a digital signal processor (DSP), the at least one of the CPU, the GPU, or the DSP including control circuitry to control data movement within the processor circuitry, arithmetic and logic circuitry to perform one or more first operations corresponding to instructions, and one or more registers to store a first result of the one or more first operation, the instructions in the apparatus, a Field Programmable Gate Array (FPGA), the FPGA including first logic gate circuitry, a plurality of configurable interconnections, and storage circuitry, the first logic gate circuitry and the plurality of configurable interconnections to perform one or more second operations, the storage circuitry to store a second result of the one or more second operations, or Application Specific Integrated Circuitry (ASIC) including second logic gate circuitry to perform one or more third operations, the processor circuitry to perform at least one of the first operations, the second operations, or the third operations to instantiate data stream classification circuitry to decode a data stream assigned to the queue of the cache to determine a traffic class assigned to the queue, and cache management circuitry to based on the traffic class assigned to the queue, allocate a portion of the cache to the queue, and transmit a signal to a memory controller to adjust allocation of the cache.

In Example 9, the subject matter of Example 8 can optionally include that the queue is a first queue, the cache is a first cache, the portion is a first portion, the signal is a first signal, and the processor circuitry is to perform the at least one the first operations, the second operations, or the third operations to instantiate the data stream classification circuitry to decode the data stream assigned to the first queue of the first cache and a second queue of a second cache to determine the traffic class assigned to the first queue and the second queue, and the cache management circuitry to based on the traffic class assigned to the second queue, allocate a second portion of the second cache to the second queue, and transmit a second signal to the memory controller to adjust allocation of the second cache.

In Example 10, the subject matter of Examples 8-9 can optionally include that the first cache includes a descriptor cache and the second cache includes a data cache.

In Example 11, the subject matter of Examples 8-10 can optionally include that the processor circuitry is to perform the at least one the first operations, the second operations, or the third operations to instantiate the cache management circuitry to allocate the portion of the cache to the queue based on a size of a packet of the traffic class assigned to the queue.

In Example 12, the subject matter of Examples 8-11 can optionally include that the processor circuitry is to perform the at least one the first operations, the second operations, or the third operations to instantiate the cache management circuitry to allocate the portion of the cache to the queue based on a priority of the traffic class assigned to the queue.

In Example 13, the subject matter of Examples 8-12 can optionally include that the traffic class was assigned to the queue by an application requesting transmission of the data stream.

In Example 14, the subject matter of Examples 8-13 can optionally include that the application requesting transmission of the data stream is implemented in an information technology/operational technology environment.

Example 15 includes a non-transitory computer readable medium comprising instructions that, when executed, cause processor circuitry to at least decode a data stream assigned to a queue of a cache to determine a traffic class assigned to the queue, based on the traffic class assigned to the queue, allocate a portion of the cache to the queue, and transmit a signal to a memory controller to adjust allocation of the cache.

In Example 16, the subject matter of Example 15 can optionally include that the queue is a first queue, the cache is a first cache, the portion is a first portion, the signal is a first signal, and the instructions, when executed, cause the processor circuitry to decode the data stream assigned to the first queue of the first cache and a second queue of a second cache to determine the traffic class assigned to the first queue and the second queue, based on the traffic class assigned to the second queue, allocate a second portion of the second cache to the second queue, and transmit a second signal to the memory controller to adjust allocation of the second cache.

In Example 17, the subject matter of Examples 15-16 can optionally include that the first cache includes a descriptor cache and the second cache includes a data cache.

In Example 18, the subject matter of Examples 15-17 can optionally include that the instructions, when executed, cause the processor circuitry to allocate the portion of the cache to the queue based on a size of a packet of the traffic class assigned to the queue.

In Example 19, the subject matter of Examples 15-18 can optionally include that the instructions, when executed, cause the processor circuitry to allocate the portion of the cache to the queue based on a priority of the traffic class assigned to the queue.

In Example 20, the subject matter of Examples 15-19 can optionally include that the traffic class was assigned to the queue by an application requesting transmission of the data stream.

In Example 21, the subject matter of Examples 15-20 can optionally include that the application requesting transmission of the data stream is implemented in an information technology/operational technology environment.

Example 22 includes an apparatus comprising means for storing having a queue, means for classifying one or more data streams to decode a data stream assigned to the queue of the means for storing to determine a traffic class assigned to the queue, and means for managing one or more means for storing to based on the traffic class assigned to the queue, allocate a portion of the means for storing to the queue, and transmit a signal to a memory controller to adjust allocation of the means for storing.

In Example 23, the subject matter of Example 22 can optionally include that the queue is a first queue, the means for storing are first means for storing, the portion is a first portion, the signal is a first signal, the means for classifying the one or more data streams is to decode the data stream assigned to the first queue of the first means for storing and a second queue of second means for storing to determine the traffic class assigned to the first queue and the second queue, and the means for managing the one or more means for storing is to based on the traffic class assigned to the second queue, allocate a second portion of the second means for storing to the second queue, and transmit a second signal to the memory controller to adjust allocation of the second means for storing.

In Example 24, the subject matter of Examples 22-23 can optionally include that the first means for storing includes means for storing one or more descriptors and the second means for storing includes means for storing data.

In Example 25, the subject matter of Examples 22-24 can optionally include that the means for managing the one or more means for storing is to allocate the portion of the means for storing to the queue based on a size of a packet of the traffic class assigned to the queue.

In Example 26, the subject matter of Examples 22-25 can optionally include that the means for managing the one or more means for storing is to allocate the portion of the means for storing to the queue based on a priority of the traffic class assigned to the queue.

In Example 27, the subject matter of Examples 22-26 can optionally include that the traffic class was assigned to the queue by an application requesting transmission of the data stream.

In Example 28, the subject matter of Examples 22-27 can optionally include that the application requesting transmission of the data stream is implemented in an information technology/operational technology environment.

Example 29 includes a method comprising decoding a data stream assigned to a queue of a cache to determine a traffic class assigned to the queue, based on the traffic class assigned to the queue, allocating a portion of the cache to the queue, and transmitting a signal to a memory controller to adjust allocation of the cache.

In Example 30, the subject matter of Example 29 can optionally include that the queue is a first queue, the cache is a first cache, the portion is a first portion, the signal is a first signal, and the method further includes decoding the data stream assigned to the first queue of the first cache and a second queue of a second cache to determine the traffic class assigned to the first queue and the second queue, based on the traffic class assigned to the second queue, allocating a second portion of the second cache to the second queue, and transmitting a second signal to the memory controller to adjust allocation of the second cache.

In Example 31, the subject matter of Examples 29-30 can optionally include that the first cache includes a descriptor cache and the second cache includes a data cache.

In Example 32, the subject matter of Examples 29-32 can optionally include allocating the portion of the cache to the queue based on a size of a packet of the traffic class assigned to the queue.

In Example 33, the subject matter of Examples 29-32 can optionally include allocating the portion of the cache to the queue based on a priority of the traffic class assigned to the queue.

In Example 34, the subject matter of Examples 29-33 can optionally include that the traffic class was assigned to the queue by an application requesting transmission of the data stream.

In Example 35, the subject matter of Examples 29-34 can optionally include that the application requesting transmission of the data stream is implemented in an information technology/operational technology environment.

Example 36 is at least one computer readable medium comprising instructions to perform the method of any of Examples 29-35.

Example 37 is an apparatus comprising processor circuitry to perform the method of any of Examples 29-35.

Example 38 is an apparatus comprising accelerator circuitry to perform the method of any of Examples 29-35.

Example 39 is an apparatus comprising one or more graphics processor units to perform the method of any of Examples 29-35.

Example 40 is an apparatus comprising one or more vision processor units to perform the method of any of Examples 29-35.

Example 41 is an apparatus comprising one or more neural network processors to perform the method of any of Examples 29-35.

Example 42 is an apparatus comprising one or more machine learning processors to perform the method of any of Examples 29-35.

Example 43 is an apparatus comprising one or more general purpose processors to perform the method of any of Examples 29-35.

Example 44 is an apparatus comprising one or more digital signal processors to perform the method of any of Examples 29-35.

Example 45 is an edge server comprising at least one of processor circuitry or accelerator circuitry to perform the method of any of Examples 29-35.

Example 46 is an edge cloud comprising at least one of processor circuitry or accelerator circuitry to perform the method of any of Examples 29-35.

Example 47 is an edge node comprising at least one of processor circuitry or accelerator circuitry to perform the method of any of Examples 29-35.

Example 48 is an apparatus comprising one or more edge gateways to perform the method of any of Examples 29-35.

Example 49 is an apparatus comprising one or more edge switches to perform the method of any of Examples 29-35.

Example 50 is an apparatus comprising at least one of one or more edge gateways or one or more edge switches to perform the method of any of Examples 29-35.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
a cache having a queue;
data stream classification circuitry to decode a data stream assigned to the queue of the cache to determine a traffic class assigned to the queue; and
cache management circuitry to:
based on the traffic class assigned to the queue, allocate a portion of the cache to the queue; and
transmit a signal to a memory controller to adjust allocation of the cache.

2. The apparatus of claim 1, wherein the queue is a first queue, the cache is a first cache, the portion is a first portion, the signal is a first signal, the data stream classification circuitry is to decode the data stream assigned to the first queue of the first cache and a second queue of a second cache to determine the traffic class assigned to the first queue and the second queue, and the cache management circuitry is to:
based on the traffic class assigned to the second queue, allocate a second portion of the second cache to the second queue; and
transmit a second signal to the memory controller to adjust allocation of the second cache.

3. The apparatus of claim 2, wherein the first cache includes a descriptor cache and the second cache includes a data cache.

4. The apparatus of claim 1, wherein the cache management circuitry is to allocate the portion of the cache to the queue based on a size of a packet of the traffic class assigned to the queue.

5. The apparatus of claim 1, wherein the cache management circuitry is to allocate the portion of the cache to the queue based on a priority of the traffic class assigned to the queue.

6. The apparatus of claim 1, wherein the traffic class was assigned to the queue by an application requesting transmission of the data stream.

7. The apparatus of claim 6, wherein the application requesting transmission of the data stream is implemented in an information technology/operational technology environment.

8. An apparatus comprising:
a cache including a queue;
processor circuitry including one or more of:
at least one of a central processor unit (CPU), a graphics processing unit (GPU), or a digital signal processor (DSP), the at least one of the CPU, the GPU, or the DSP including control circuitry to control data movement within the processor circuitry, arithmetic and logic circuitry to perform one or more first operations corresponding to instructions, and one or more registers to store a first result of the one or more first operation, the instructions in the apparatus;
a Field Programmable Gate Array (FPGA), the FPGA including first logic gate circuitry, a plurality of configurable interconnections, and storage circuitry, the first logic gate circuitry and the plurality of configurable interconnections to perform one or more second operations, the storage circuitry to store a second result of the one or more second operations; or
Application Specific Integrated Circuitry (ASIC) including second logic gate circuitry to perform one or more third operations;
the processor circuitry to perform at least one of the first operations, the second operations, or the third operations to instantiate:
data stream classification circuitry to decode a data stream assigned to the queue of the cache to determine a traffic class assigned to the queue; and
cache management circuitry to:
based on the traffic class assigned to the queue, allocate a portion of the cache to the queue; and
transmit a signal to a memory controller to adjust allocation of the cache.

9. The apparatus of claim 8, wherein the queue is a first queue, the cache is a first cache, the portion is a first portion, the signal is a first signal, and the processor circuitry is to perform the at least one the first operations, the second operations, or the third operations to instantiate:
the data stream classification circuitry to decode the data stream assigned to the first queue of the first cache and a second queue of a second cache to determine the traffic class assigned to the first queue and the second queue; and
the cache management circuitry to:
based on the traffic class assigned to the second queue, allocate a second portion of the second cache to the second queue; and
transmit a second signal to the memory controller to adjust allocation of the second cache.

10. The apparatus of claim 9, wherein the first cache includes a descriptor cache and the second cache includes a data cache.

11. The apparatus of claim 8, wherein the processor circuitry is to perform the at least one the first operations, the second operations, or the third operations to instantiate the cache management circuitry to allocate the portion of the cache to the queue based on a size of a packet of the traffic class assigned to the queue.

12. The apparatus of claim 8, wherein the processor circuitry is to perform the at least one the first operations, the second operations, or the third operations to instantiate the cache management circuitry to allocate the portion of the cache to the queue based on a priority of the traffic class assigned to the queue.

13. The apparatus of claim 8, wherein the traffic class was assigned to the queue by an application requesting transmission of the data stream.

14. The apparatus of claim 13, wherein the application requesting transmission of the data stream is implemented in an information technology/operational technology environment.

15. A non-transitory computer readable medium comprising instructions that, when executed, cause processor circuitry to at least:
decode a data stream assigned to a queue of a cache to determine a traffic class assigned to the queue;
based on the traffic class assigned to the queue, allocate a portion of the cache to the queue; and
transmit a signal to a memory controller to adjust allocation of the cache.

16. The non-transitory computer readable medium of claim 15, wherein the queue is a first queue, the cache is a first cache, the portion is a first portion, the signal is a first signal, and the instructions, when executed, cause the processor circuitry to:
decode the data stream assigned to the first queue of the first cache and a second queue of a second cache to determine the traffic class assigned to the first queue and the second queue;
based on the traffic class assigned to the second queue, allocate a second portion of the second cache to the second queue; and
transmit a second signal to the memory controller to adjust allocation of the second cache.

17. The non-transitory computer readable medium of claim 16, wherein the first cache includes a descriptor cache and the second cache includes a data cache.

18. The non-transitory computer readable medium of claim 15, wherein the instructions, when executed, cause the processor circuitry to allocate the portion of the cache to the queue based on a size of a packet of the traffic class assigned to the queue.

19. The non-transitory computer readable medium of claim 15, wherein the instructions, when executed, cause the processor circuitry to allocate the portion of the cache to the queue based on a priority of the traffic class assigned to the queue.

20. The non-transitory computer readable medium of claim 15, wherein the traffic class was assigned to the queue by an application requesting transmission of the data stream.

21. The non-transitory computer readable medium of claim 20, wherein the application requesting transmission of the data stream is implemented in an information technology/operational technology environment.

22. An apparatus comprising:
means for storing having a queue;
means for classifying one or more data streams to decode a data stream assigned to the queue of the means for storing to determine a traffic class assigned to the queue; and
means for managing one or more means for storing to:
based on the traffic class assigned to the queue, allocate a portion of the means for storing to the queue; and
transmit a signal to a memory controller to adjust allocation of the means for storing.

23. The apparatus of claim 22, wherein the queue is a first queue, the means for storing are first means for storing, the portion is a first portion, the signal is a first signal, the means for classifying the one or more data streams is to decode the data stream assigned to the first queue of the first means for storing and a second queue of second means for storing to determine the traffic class assigned to the first queue and the second queue, and the means for managing the one or more means for storing is to:
based on the traffic class assigned to the second queue, allocate a second portion of the second means for storing to the second queue; and
transmit a second signal to the memory controller to adjust allocation of the second means for storing.

24. The apparatus of claim 23, wherein the first means for storing includes means for storing one or more descriptors and the second means for storing includes means for storing data.

25. The apparatus of claim 22, wherein the means for managing the one or more means for storing is to allocate the portion of the means for storing to the queue based on a size of a packet of the traffic class assigned to the queue.

26.-35. (canceled)
